(19) United States
(12) Patent Application Publication
(10) Pub. No.: US 2010/0089618 A1
(43) Pub. Date: Apr. 15, 2010

(54) FENCE POST INSULATOR

(76) Inventor: Brad Alan Clippinger, West Mansfield, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 12/578,805

(22) Filed: Oct. 14, 2009

Related U.S. Application Data
(60) Provisional application No. 61/105,187, filed on Oct. 14, 2008.

(51) Int. Cl. H01B 17/14; B23P 11/00

(52) U.S. Cl. 174/158 F; 29/428

(57) ABSTRACT

A fencepost insulator that can be quickly and easily mounted on a wire of an electric fence for providing an electrically-resistive barrier between the electrified wire and a conductive fencepost. The insulator is a unitary, roll-shaped segment of electrically-resistive material with a loose spiral-shaped cross section. The insulator is installed by manually rolling the insulator onto a wire, thereby allowing the insulator to be conveniently installed at any location along the length of the wire.

### CROSS-REFERENCE TO RELATED APPLICATIONS

The application claims the benefit of U.S. Provisional Application No. 61/105,187 filed Oct. 14, 2008, which is herein incorporated by reference.

### STATEMENT REGARDING FEDERALLY-SPONSORED RESEARCH AND DEVELOPMENT

Not applicable.

### REFERENCE TO AN APPENDIX

Not applicable.

### BACKGROUND OF THE INVENTION

1. Field of the Invention

This invention relates generally to fencepost insulators and relates more particularly to an insulator that can be quickly and easily rolled onto a wire of an electric fence for providing an electrically-resistive barrier between the electrified wire and a conductive or non-conductive fencepost.

2. Description of the Related Art

Electric fences are commonly used to limit the movement of animals, and particularly livestock, to predetermined areas that typically range in size from several acres to many hundreds of acres. A typical fence is defined by a series of vertically spaced, horizontal wires that extend along, and are fastened to, a plurality of vertical fenceposts that are disposed at intervals around the periphery of the designated area of confinement. A low voltage is applied to the wires to provide a mild shock when an animal comes into contact with a wire. Confined animals are thus discouraged from engaging the fence, thereby keeping the animals within the area of confinement.

A common problem associated with electric fences is that fenceposts, which are typically made of wood, steel, or even living trees if situated properly, are electrically conductive. Thus, an electrical short can result if an electrified wire comes into contact with a post. Traditionally, in order to prevent contact between the wires and the posts of electric fences, small sections of tubing formed of electrically-resistive material (commonly referred to as “electric fence insulators”) are longitudinally slid, or strung, onto the wires (i.e., the wires are threaded through the sections of tubing) before the wires are mounted to the fenceposts. The insulators are then slid further along the wires to positions that correspond to the locations of the fenceposts. U-shaped staples or other suitable fasteners are then used to fasten the wires to the fenceposts, with the sections of tubing providing an electrically-resistive barrier therebetween.

Due to the large number of fenceposts used to assemble a typical electric fence, and due to the fact that a typical electric fence wire can be many thousands of feet in length, it can be, and typically is, extremely tedious and time consuming to thread a requisite number of traditional, tubular electric fence insulators onto a length of wire and shift them to their proper locations along the wire. Moreover, once a wire of an electric fence is installed (i.e., fastened to a fencepost), it is generally impossible to string more insulators onto the wire and slide them to appropriate locations, which can be thousands of feet from an end of the wire, in order to replace existing insulators that are worn or damaged. Thus, in order to replace a worn or damaged insulator on a wire at a particular fencepost location, a new tubular insulator must be longitudinally slit and radially slipped onto the wire at the area of contact with fencepost. This method of replacement compromises the structural integrity of the replacement insulator and can significantly reduce the insulator's efficacy and/or longevity, thereby increasing the probability and frequency of electrical shorts occurring along the wire. There is therefore a need for a fencepost insulator that can be easily and effectively installed and replaced.

### BRIEF SUMMARY OF THE INVENTION

In accordance with the present invention, an electric fence insulator is provided that can quickly and easily be mounted to a wire of an electric fence for providing an electrically-resistive barrier between the electrified wire and a conductive fencepost. The insulator is formed of a segment of electrically-resistive material, and preferably polyolefin, that is generally roll-shaped with a cross-section shaped like a loose spiral terminating in an innermost central channel.

To mount the insulator onto a wire of an electric fence, the insulator is manually rolled onto the wire until the wire reaches the central channel of the insulator and held in a generally coaxial relationship therewith. Preferably, the wire snaps into the central channel with a palpable sensation and generally cannot be removed from the channel without deliberate effort.

After the insulator has been mounted on a wire, a conventional fastener, and preferably a U-shaped staple, is used to secure the insulator (and the wire held therein) to a fencepost. The staple preferably crimps the insulator against the fencepost to further secure the wire. The insulator thereafter provides an electrically-resistive barrier between the wire and the fencepost.

### BRIEF DESCRIPTION OF THE SEVERAL VIEWS OF THE DRAWINGS

FIG. 1 is a perspective view illustrating a preferred embodiment of the present invention.

FIG. 2a is an end-on view illustrating the preferred embodiment of the present invention shown in FIG. 1.

FIG. 2b is an end-on view illustrating an alternative embodiment of the present invention with a triangular spiral-shaped cross section.

FIG. 2c is an end-on view illustrating an alternative embodiment of the present invention with a rectangular spiral-shaped cross section.

FIG. 3 is a perspective view illustrating the preferred embodiment of the present invention shown in FIG. 1 being installed on a wire.

FIG. 4 is a perspective view illustrating the preferred embodiment of the present invention shown in FIG. 1 being fastened to a fencepost.

FIG. 5 is a perspective view illustrating the preferred embodiment of the present invention shown in FIG. 1 operatively mounted to a fencepost.

FIG. 6 is a perspective view illustrating several of the inventive fencepost insulators operatively mounted to a fencepost.

FIG. 7 is a perspective view illustrating an alternative embodiment of the present invention having a stabilizing fin.

FIG. 8 is a perspective view illustrating the alternative embodiment of the present invention shown in FIG. 7 operatively mounted to a fencepost.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

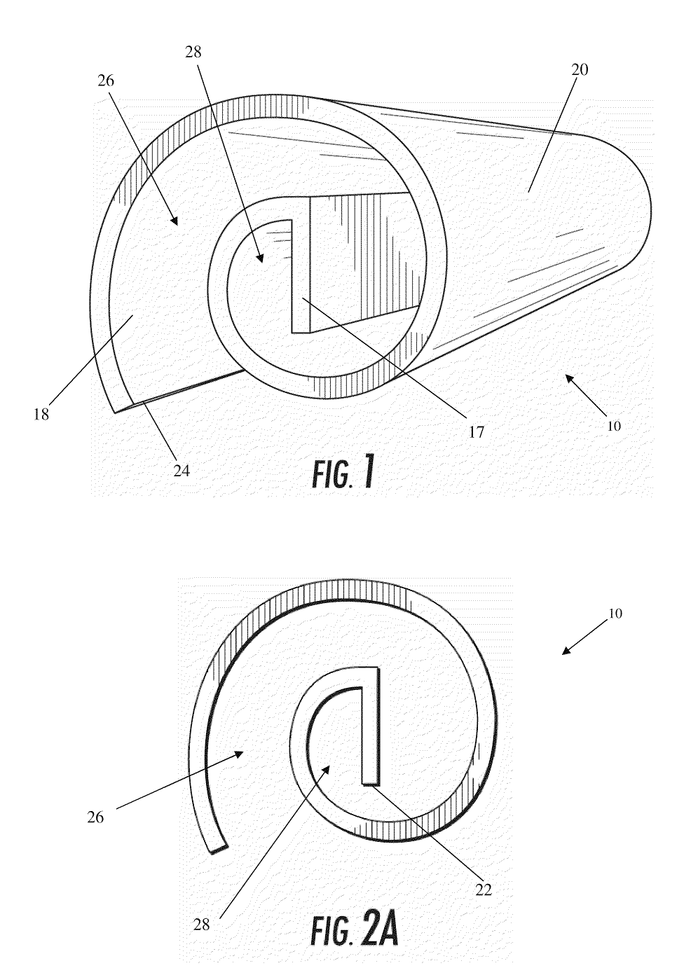

An improved electric fence insulator, indicated generally at 10, is shown in FIGS. 1, 2a, and 5. The insulator 10 can be quickly and easily mounted to a wire 12 of an electric fence for providing an electrically-resistive barrier between the electrified wire 12 and a conductive, non-conductive or semi-conductive fencepost 16.

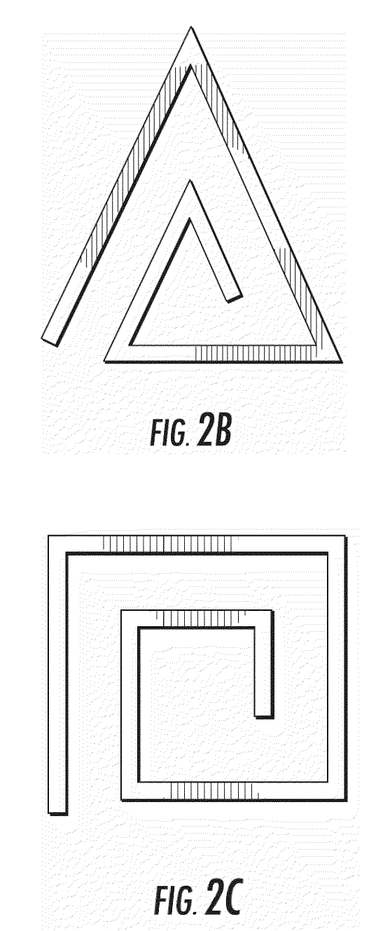

The insulator 10 is generally roll-shaped with a cross-section shaped like a loose circular spiral that terminates in an inwardly-extending, planar lip 17. The term “roll-shaped” is used herein to describe the configuration of the insulator 10 in the preferred embodiment shown in FIG. 1. “Roll-shaped” means the shape a relatively flexible sheet of material, such as stiff paper or plastic, takes when it is rolled from a plane into a tube, but without contact between overlapping layers of the material. Instead, a gap is formed between overlapping layers, as shown in FIGS. 1 and 2, and that gap is substantially the same dimension along the length of the insulator 10, and at all radial distances from the center of the insulator 10.

The insulator 10 has an inner surface 18, an outer surface 20, an inner edge 22, an outer edge 24 and a generally spiral-shaped channel 26 defined by the inner and outer surfaces 18 and 20. A generally D-shaped central channel 28 is defined by the inner surface 20 of the insulator 10 at the inner terminus of the spiral-shaped channel 26. An alternative embodiment of the insulator 10 is contemplated wherein the planar lip 17 is omitted and the insulator extends along an inward spiral an additional 180 degrees, thereby creating a central channel that is generally tubular instead of D-shaped as with the insulator 10.

The insulator 10 is preferably formed of an inexpensive, electrically-resistive (high electrical resistivity) material, and more preferably a flexible polymer such as polyolefin, although any sufficiently resistive material is contemplated, including, but not limited to various plastics, glasses, ceramics, composites, and non-conductive metals. The insulator 10 is manufactured using hot die extrusion, although it is contemplated that any suitable manufacturing technique can be used to form the insulator 10, including, but not limited to injection molding, blow molding, or even by manually folding and rolling a sheet of electrically-resistive material into the shape shown herein described above.

The insulator 10 has a preferred length in a range of about 3 inches to about 8 inches, with a more preferred range of about 4 inches to about 6 inches, although shorter and longer insulators are contemplated. The sheet of the insulator 10 has a preferred thickness in a range of about 0.5 millimeters to about 4 millimeters, with a more preferred range of about 1 millimeter to about 2 millimeters, although thinner and thicker insulators are contemplated. The outer diameter of the rolled insulator 10 is in a preferred range of about 0.5 inches to about 2 inches.

Although the insulator 10 is shown as having a circular spiral-shaped cross-section, it is contemplated that the insulator 10 may alternatively have other types of generally spiral-shaped cross-sections, including, but not limited to, oval, rectangular, triangular, irregular, or any combination thereof. See FIGS. 2b and 2c for some examples of such alternatives.

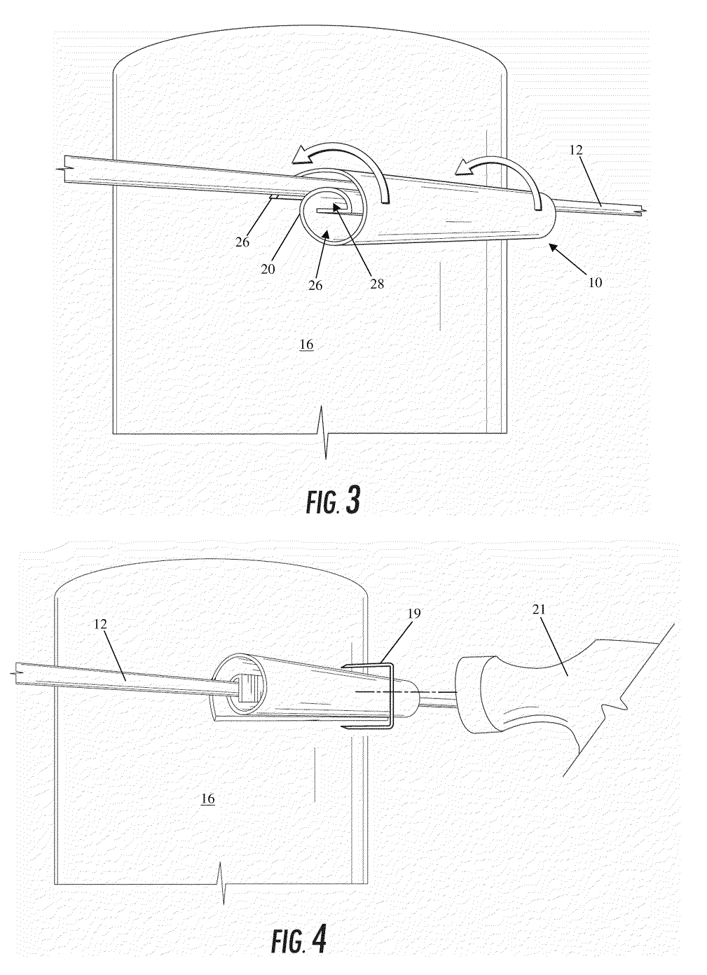

In order to mount the improved insulator 10 onto the wire 12 of the electric fence 14, the insulator 10 is manually rolled onto the wire as shown in FIG. 3. The insulator 10 is orientated substantially parallel to the wire 12 with the wire 12 entering the spiral-shaped channel 26 between the outer edge 24 and the outer surface 20 of the insulator 10. The insulator 10 is then rolled further around the wire 12, with the wire 12 advancing through the spiral-shaped channel 26 toward the center of the insulator 10, until the wire 12 reaches the inner terminus of the spiral-shaped channel 26 and is situated in the central channel 28 in a generally coaxial relationship thereto.

Preferably, the shortest distance between the inner edge 22 of the insulator 10 and the inner surface 20 of the insulator 10 is approximately equal to, or slightly shorter than, the diameter of the wire 12. Because the insulator 10 and/or the wire 12 are preferably formed of flexible materials, a distinct, palpable engagement is felt when the wire 12 is “snapped” into the central channel 28 of the insulator 10. Furthermore, the wire is firmly held within the central channel 28 and generally cannot be removed from the channel 28 without deliberate prying.

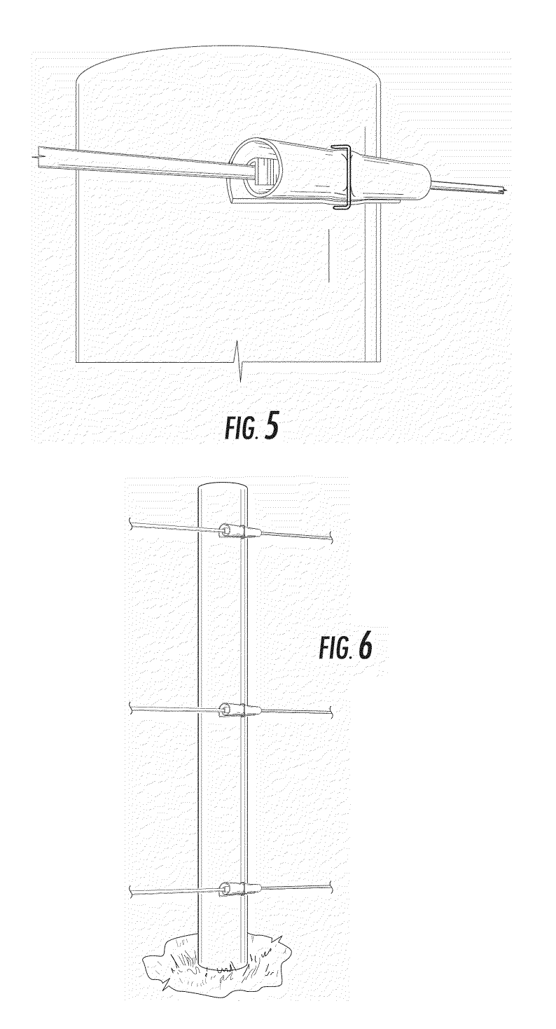

Referring to FIGS. 4 and 5, after the insulator 10 has been mounted on the wire 12 a conventional U-shaped staple 19 or other suitable fastener is used to secure the insulator 10 and wire 12 to the fencepost 16 in a conventional manner, such as with a hammer 21. Because the insulator 10 is preferably formed of a flexible material, the staple preferably slightly flattens or crimps the insulator 10 against the fencepost 16 to secure the wire 12 as shown in FIG. 5. The improved insulator 10 can thus be mounted at substantially any position along the length of a wire during installation or replacement, and does not need to be threaded onto a wire for installation, or structurally compromised for replacement, as with traditional, tubular insulators. In most applications, several insulators will be installed on the same fencepost for insulating a plurality of electrified wires that are mounted to the post in a parallel configuration, as shown in FIG. 6.

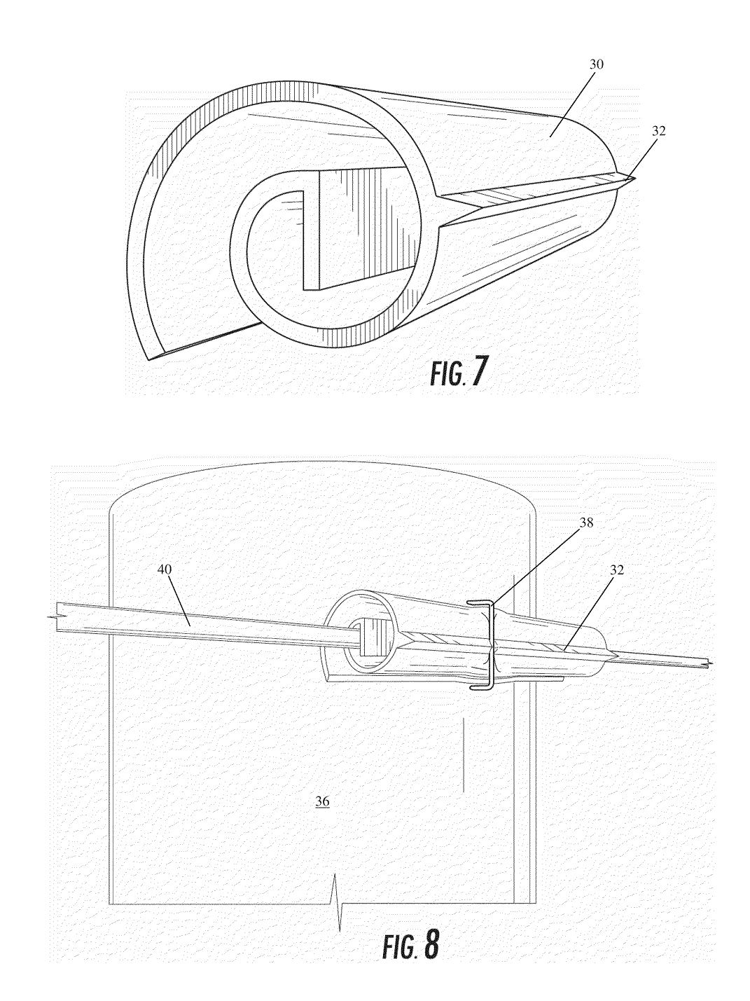

Referring to FIG. 7, an alternative embodiment 30 of the inventive insulator 10 is contemplated that features a stabilizing fin 32. The stabilizing fin 32 is an elongated segment of material that extends from, and is preferably contiguous with, the outer surface 34 of the insulator 30. The stabilizing fin 32 extends in substantially the opposite direction of the surface of the insulator 30 that abuts the fencepost 36 when the insulator is installed. When a fastener 38 is used to mount the insulator 30 to the fencepost 36 in the manner described above, the fastener 30 “bites” into the stabilizing fin 32 as the insulator 30 is crimped against the fencepost 36, as shown in FIG. 8. With the fastener 38 situated within the stabilizing fin 32 thusly, the insulator 30 is inhibited from shifting longitudinally along the wire 40.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A fencepost insulator for providing an electrically-resistive barrier between a fencepost and an electrified wire mounted thereto, the insulator comprising an elongated, generally roll-shaped segment of electrically-resistive material with a cross-section shaped like a loose spiral having a central channel for holding the wire.

2. The fencepost insulator in accordance with claim 1, further comprising a planar lip extending from an innermost terminus of a curved portion of the insulator to form a boundary of the central channel.

3. The fencepost insulator in accordance with claim 1, wherein the insulator is formed of a flexible polymer.

4. The fencepost insulator in accordance with claim 3, wherein the insulator is formed of polyolefin.

5. The fencepost insulator in accordance with claim 1, wherein the insulator has a length in a range of about 3 inches to about 8 inches.

6. The fencepost insulator in accordance with claim 5, wherein the insulator has a length in a range of about 4 inches to about 6 inches.

7. The fencepost insulator in accordance with claim 1, wherein the insulator has a thickness in a range of about 0.5 millimeters to about 4 millimeters.

8. The fencepost insulator in accordance with claim 7, wherein the insulator has a thickness in a range of about 1 millimeter to about 2 millimeters.

9. The fencepost insulator in accordance with claim 1, wherein the cross section of the insulator is shaped like a loose circular spiral.

10. The fencepost insulator in accordance with claim 1, wherein the cross section of the insulator is shaped like a loose rectangular spiral.

11. The fencepost insulator in accordance with claim 1, wherein the cross section of the insulator is shaped like a loose triangular spiral.

12. The fencepost insulator in accordance with claim 1, further comprising a stabilizing fin extending from an outer surface of the insulator for allowing a fastener to bitingly engage the stabilizing fin to prevent movement of the insulator along the wire.

13. A fencepost insulator for providing an electrically-resistive barrier between a fencepost and an electrified wire mounted thereto, the insulator comprising an elongated, generally roll-shaped segment of electrically-resistive material with a cross-section shaped like a loose spiral having a central channel, wherein the wire extends longitudinally through the central channel and the insulator is mounted to the fencepost with a fastener.

14. A method for providing an electrically-resistive barrier between a fencepost and an electrified wire mounted thereto using an insulator formed of an elongated, generally roll-shaped segment of electrically-resistive material with a cross-section shaped like a loose spiral having a central channel, the method comprising rolling the insulator onto the wire with the insulator orientated substantially parallel to the wire and with the wire entering a spiral-shaped channel between an outermost edge and an outer surface of the insulator, the wire advancing through the spiral-shaped channel toward the center of the insulator until the wire reaches an inner terminus of the spiral-shaped channel and is situated in the central channel in a generally coaxial relationship therewith.

15. The method in accordance with claim 13, further comprising securing the insulator and the wire to a fence post with a conventional fastener.

16. The method in accordance with claim 13, further comprising securing the insulator and the wire to a fence post with a U-shaped staple.
